(19) United States
(12) Patent Application Publication
(10) Pub. No.: US 2024/0119369 A1
(43) Pub. Date: Apr. 11, 2024

(54) CONTEXTUAL LEARNING AT THE EDGE

(71) Applicant: Telefonaktiebolaget LM Ericsson (publ), Stockholm (SE)

(72) Inventors: Kristijonas CYRAS, San Jose, CA (US); Athanasios KARAPANTELAKIS, Solna (SE); Marin ORLIC, Bromma (SE); Jörg NIEMÖLLER, Sollentuna (SE); Leonid MOKRUSHIN, Uppsala (SE); Aneta Vulgarakis FELJAN, Stockholm (SE); Ramamurthy BADRINATH, Bangalore Karnataka (IN)

(21) Appl. No.: 18/546,344

(22) PCT Filed: Feb. 17, 2021
(86) PCT No.: PCT/IB2021/051334

§ 371 Date: Aug. 14, 2023

(51) Int. Cl. G06N 20/00; H04L 67/10

(52) U.S. Cl. CPC G06N 20/00; H04L 67/10

(57) ABSTRACT

There is provided a method performed by a central entity of a network. A first set of features is selected for a machine learning model to take into account when analysing data. The machine learning model is to be deployed at an edge entity of the network. The selection is based on first information indicative of data that is available for the machine learning model to analyse, second information indicative of features that are available for the machine learning model to take into account when analysing data, and contextual information associated with the network.

### TECHNICAL FIELD

The disclosure relates to a method for selecting a set of features for a machine learning model and an entity configured to operate in accordance with that method.

### BACKGROUND

Edge computing is an established and rapidly growing technique, especially in the field of telecommunications. In content delivery networks, machine learning (ML) models are often deployed at the edge of a network to analyse local data. For instance, at a radio base station (RBS), data from local performance measurement (PM) counters can be collected and analysed by ML models (e.g. using categorical data) to discover service degradation in order to raise alarms and hypothesise the root cause of the degradation.

ML models deployed at the edge of a network are often forced to train and/or make predictions (or perform inferencing) with reduced data for a variety of reasons. One reason is that ML models need to save compute resources, data store resources, and transport resources. Another reason is that ML models need to adhere to potential service level agreement (SLA) restrictions regarding training and/or prediction response time. Yet another reason is that reduced data can help to avoid overfitting, which is a fundamental consideration for the performance of an ML model. In general, the more data that is used, the more the ML model depends on the data and thus the higher the chances of overfitting.

In order to reduce data, dimensionality reduction techniques can be used. ML models often analyse data based on features of the data. Thus, some dimensionality reduction techniques reduce the data by reducing the feature space. For example, only the most statistically significant or informative features and their values may be used, or some mathematical functions in an ML model (e.g. neurons in the case of the ML model being a neural network) may be purposefully conditionally activated in order not to consider certain data inputs or their propagation. This results in the ML model analysing less data than is locally available.

However, a problem exists with dimensionality reduction in that a ML model at the edge of the network is likely to ignore locally available or obtainable data that may otherwise improve the performance of the ML model. Indeed, some collectable data may be deemed irrelevant or statistically insignificant (e.g. during training by an autoencoder or for deployment in the specific environment) at the edge of the network, but that data may in fact be relevant and/or causally important.

### SUMMARY

It is thus an object of the disclosure to obviate or eliminate at least some of the above-described disadvantages associated with existing techniques.

In particular, as mentioned above, in existing dimensionality reduction techniques, it may be the case that collectable data deemed irrelevant or statistically insignificant (e.g. during training by an autoencoder or for deployment in the specific environment) at the edge of a network is actually relevant and/or causally important. It is thus advantageous to take into account contextual information in order to identify such data that may actually be relevant and/or causally important, since this data may improve the performance of a machine learning model deployed at the edge of the network. However, there is currently no mechanism that prompts a machine learning model to use additional and/or different data to improve its performance. It would thus be valuable to provide a feedback mechanism, from a central entity (such as an operations support system, OSS) to an edge entity at which a machine learning model is to be deployed, that allows this.

Therefore, according to an aspect of the disclosure, there is provided a method performed by a central entity of a network. The method comprises selecting a first set of features for a machine learning model to take into account when analysing data. The machine learning model is to be deployed at an edge entity of the network. The selection is based on first information indicative of data that is available for the machine learning model to analyse, second information indicative of features that are available for the machine learning model to take into account when analysing data, and contextual information associated with the network.

According to another aspect of the disclosure, there is provided a central entity configured to operate in accordance with the method. In some embodiments, the central entity may comprise processing circuitry configured to operate in accordance with the method. In some embodiments, the central entity may comprise at least one memory for storing instructions which, when executed by the processing circuitry, cause the central entity to operate in accordance with the method.

According to another aspect of the disclosure, there is provided a network comprising the central entity and the edge entity.

According to another aspect of the disclosure, there is provided a computer program comprising instructions which, when executed by processing circuitry, cause the processing circuitry to perform the method.

According to another aspect of the disclosure, there is provided a computer program product, embodied on a non-transitory machine-readable medium, comprising instructions which are executable by processing circuitry to cause the processing circuitry to perform the method.

Therefore, there is provided an advantageous technique for selecting a set of features for a machine learning model to take into account when analysing data. In particular, according to the technique described herein, a first set of features for a machine learning model to take into account when analysing data is selected based on contextual information associated with the network. In this way, the set of features that is selected will be more relevant and/or important. This can improve the performance of the machine learning model that is to be deployed at an edge entity of the network.

### BRIEF DESCRIPTION OF THE DRAWINGS

For a better understanding of the technique, and to show how it may be put into effect, reference will now be made, by way of example, to the accompanying drawings, in which:

FIG. 1 is a block diagram illustrating a central entity according to an embodiment;

FIG. 2 illustrates a method performed by a central entity according to an embodiment;

FIG. 3 is a schematic of a network according to an embodiment;

FIG. 4 is a signalling diagram illustrating an exchange of signals in a network according to an embodiment;

FIG. 5 is an example of a knowledge graph; and

FIG. 6 is an example of a knowledge graph.

### DETAILED DESCRIPTION

Some of the embodiments contemplated herein will now be described more fully with reference to the accompanying drawings. Other embodiments, however, are contained within the scope of the subject-matter disclosed herein, the disclosed subject-matter should not be construed as limited to only the embodiments set forth herein; rather, these embodiments are provided by way of example to convey the scope of the subject-matter to those skilled in the art.

As mentioned earlier, there is described herein an advantageous technique for selecting a set of features for a machine learning model to take into account when analysing data. The method described herein can be a computer-implemented method. The method described herein can be implemented by a central entity of a network. The central entity can communicate with one or more edge entities of the network to implement the method described herein. The central entity and the one or more edge entities can communicate (e.g. transmit to each other) over a communication channel. In some embodiments, the central entity and the one or more edge entities may communicate over the cloud. The method described herein can be implemented in the cloud according to some embodiments.

The network referred to herein can also be referred to as a telecommunications network. For example, the network referred to herein can be a mobile network, such as a fourth generation (4G) mobile network, a fifth generation (5G) mobile network, a sixth generation (6G) mobile network, or any other generation mobile network. In some embodiments, the network can be a radio access network (RAN), or any other type of telecommunications network.

The central entity referred to herein can be any entity that is central to the network. The central entity referred to herein can operate in a centralised manner. The central entity can, for example, provide central support to (e.g. have central control over) other entities of the network, such as one or more edge entities of the network. For example, in some embodiments, the central entity referred to herein can be an entity of an operations support system (OSS) of the network. In some embodiments, the central entity referred to herein may be a central server or data center. Thus, the central entity may also be referred to as a (first) network node.

The edge entity referred to herein can be any entity that is located at the edge of the network. The edge entity referred to herein can operate in a decentralised manner. An entity that is located at the edge of the network is closer to an end user (e.g. a service consumer) than an entity that is central to the network. The edge of the network is where the data to be analysed is actually generated. The data to be analysed can, for example, comprise data from one or more data acquisition units (e.g. one or more counters, such as one or more performance management, PM, counters) of the edge entity. In some embodiments, the edge entity referred to herein may be a device or a base station, such as a radio base station (RBS), a Node B, an evolved Node B (eNB), a new radio NR NodeB (gNBs), or any other base station. Thus, the edge entity may also be referred to as a (second) network node.

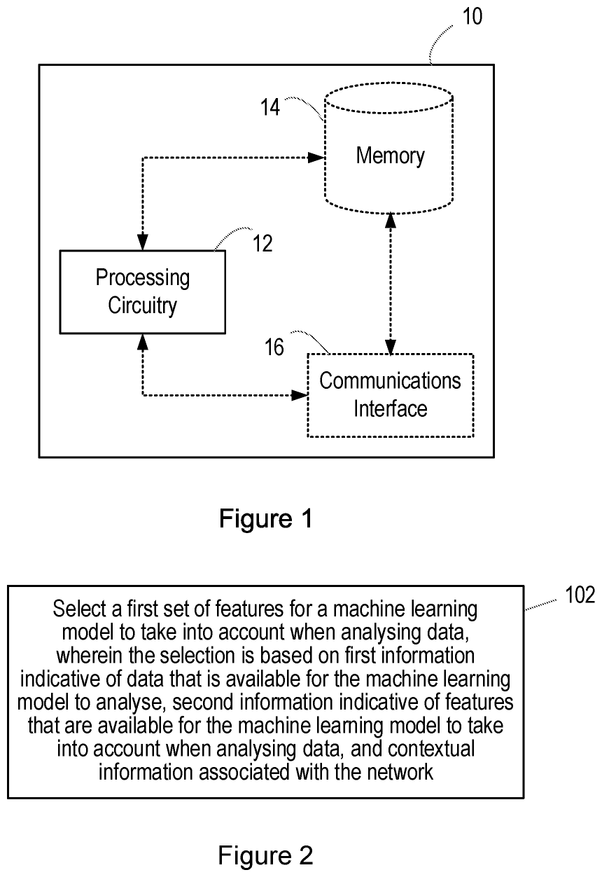

FIG. 1 illustrates a central entity 10 in accordance with an embodiment. The central entity 10 is for selecting a set of features for a machine learning model to take into account when analysing data. The central entity 10 referred to herein can refer to equipment capable, configured, arranged and/or operable to communicate directly or indirectly with one or more edge entities, and/or with other network nodes or equipment to enable and/or to perform the functionality described herein. The central entity 10 referred to herein may be a physical node (e.g. a physical machine) or a virtual node (e.g. a virtual machine, VM).

As illustrated in FIG. 1, the central entity 10 comprises processing circuitry (or logic) 12. The processing circuitry 12 controls the operation of the central entity 10 and can implement the method described herein in respect of the central entity 10. The processing circuitry 12 can be configured or programmed to control the central entity 10 in the manner described herein. The processing circuitry 12 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the central entity 10. In some embodiments, the processing circuitry 12 can be configured to run software to perform the method described herein in respect of the central entity 10. The software may be containerised according to some embodiments. Thus, in some embodiments, the processing circuitry 12 may be configured to run a container to perform the method described herein in respect of the central entity 10.

Briefly, the processing circuitry 12 of the central entity 10 is configured to select a first set of features for a machine learning model to take into account when analysing data. The machine learning model is to be deployed at an edge entity of the network. The selection of the first set of features is based on first information indicative of data that is available for the machine learning model to analyse, second information indicative of features that are available for the machine learning model to take into account when analysing data, and contextual information associated with the network.

As illustrated in FIG. 1, in some embodiments, the central entity 10 may optionally comprise a memory 14. The memory 14 of the central entity 10 can comprise a volatile memory or a non-volatile memory. In some embodiments, the memory 14 of the central entity 10 may comprise a non-transitory media. Examples of the memory 14 of the central entity 10 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 12 of the central entity 10 can be connected to the memory 14 of the central entity 10. In some embodiments, the memory 14 of the central entity 10 may be for storing program code or instructions which, when executed by the processing circuitry 12 of the central entity 10, cause the central entity 10 to operate in the manner described herein in respect of the central entity 10. For example, in some embodiments, the memory 14 of the central entity 10 may be configured to store program code or instructions that can be executed by the processing circuitry 12 of the central entity 10 to cause the central entity 10 to operate in accordance with the method described herein in respect of the central entity 10. Alternatively or in addition, the memory 14 of the central entity 10 can be configured to store any information, data, messages, requests, responses, indications, notifications, signals, or similar, that are described herein. The processing circuitry 12 of the central entity 10 may be configured to control the memory 14 of the central entity 10 to store information, data, messages, requests, responses, indications, notifications, signals, or similar, that are described herein.

In some embodiments, as illustrated in FIG. 1, the central entity 10 may optionally comprise a communications interface 16. The communications interface 16 of the central entity 10 can be connected to the processing circuitry 12 of the central entity 10 and/or the memory 14 of central entity 10. The communications interface 16 of the central entity 10 may be operable to allow the processing circuitry 12 of the central entity to communicate with the memory 14 of the central entity 10 and/or vice versa. Similarly, the communications interface 16 of the central entity 10 may be operable to allow the processing circuitry 12 of the central entity 10 to communicate with any one or more of the edge entities referred to herein and/or any other entity referred to herein. The communications interface 16 of the central entity 10 can be configured to transmit and/or receive information, data, messages, requests, responses, indications, notifications, signals, or similar, that are described herein. In some embodiments, the processing circuitry 12 of the central entity 10 may be configured to control the communications interface 16 of the central entity 10 to transmit and/or receive information, data, messages, requests, responses, indications, notifications, signals, or similar, that are described herein.

Although the central entity 10 is illustrated in FIG. 1 as comprising a single memory 14, it will be appreciated that the central entity 10 may comprise at least one memory (i.e. a single memory or a plurality of memories) 14 that operate in the manner described herein. Similarly, although the central entity 10 is illustrated in FIG. 1 as comprising a single communications interface 16, it will be appreciated that the central entity 10 may comprise at least one communications interface (i.e. a single communications interface or a plurality of communications interface) 16 that operate in the manner described herein. It will also be appreciated that FIG. 1 only shows the components required to illustrate an embodiment of the central entity 10 and, in practical implementations, the central entity 10 may comprise additional or alternative components to those shown.

Although not illustrated, it will be appreciated that any one or more of the edge entities referred to herein may comprises one or more of the same components (e.g. processing circuitry, memory, and/or communications interface) as the central entity 10.

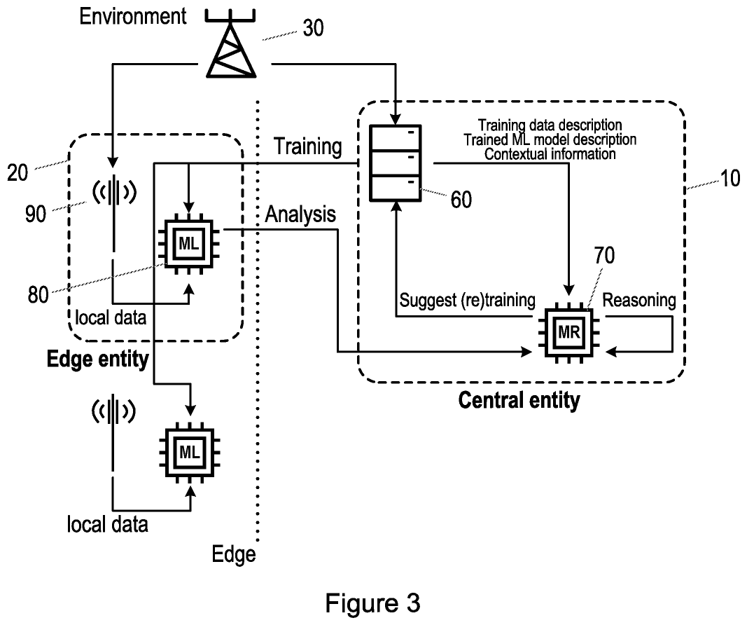

FIG. 2 illustrates a method performed by a central entity 10 in accordance with an embodiment. The method is for selecting a set of features for a machine learning model to take into account when analysing data. The central entity 10 described earlier with reference to FIG. 1 can be configured to operate in accordance with the method of FIG. 2. The method can be performed by or under the control of the processing circuitry 12 of the central entity 10 according to some embodiments.

With reference to FIG. 2, as illustrated at block 102, a first set of features is selected for a machine learning model to take into account when analysing data. More specifically, the central entity 10 (or the processing circuitry 12 of the central entity 10) selects the first set of features for the machine learning model to take into account when analysing data. The machine learning model is to be deployed at an edge entity of the network. The selection of the first set of features is based on first information indicative of data that is available for the machine learning model to analyse, second information indicative of features that are available for the machine learning model to take into account when analysing data, and contextual information associated with the network.

The selection of the first set of features based on the first information can comprise selecting a first set of features comprising (only) features corresponding to data that is actually available for the machine learning model to analyse. In some embodiments, the data that is available for the machine learning model to analyse can comprise data that is local to the edge entity, e.g. data from one or more memories and/or one or more data acquisition units of the edge entity. The selection of the first set of features based on the second information can comprise selecting a first set of features comprising (only) features that are actually available for the machine learning model to take into account when analysing data.

In some embodiments, the first set of features may comprise one or more features that are inferred (or determined) by the central entity 10 (or the processing circuitry 12 of the central entity 10), from the contextual information associated with the network, to improve the performance of the machine learning model. By taking into account contextual information associated with the network in the selection of the first set of features, it may be that one or more features that would otherwise be statistically deemed irrelevant and/or unimportant are actually selected as part of the first set of features, since it can be determined from the contextual information associated with the network that these one or more features are actually relevant and/or important. In some embodiments, the machine learning model may initially be configured not to use specific features (or values for those features), but at least some of those features may be determined by the central entity 10 (or the processing circuitry 12 of the central entity 10) to be relevant and/or important in view of the contextual information associated with the network. Thus, the selected first set of features can comprise these features. On the other hand, the machine learning model may initially be configured to use specific features (or values for those features), but at least some of those features may be determined by the central entity 10 (or the processing circuitry 12 of the central entity 10) to be irrelevant and/or unimportant in view of the contextual information associated with the network. Thus, the selected first set of features may omit these features.

The machine learning model referred to herein can be any type of machine learning model. Examples of a machine learning model include, but are not limited to, a neural network, a decision tree, or any other type of machine learning model. The set of features referred to herein may also be referred to as a set of attributes or a set of parameters. The set of features can comprise one or more features. A feature can be a (numeric) value, a string, a graph, or any other type of feature. A feature is a measurable property or characteristic of data that is to be analysed. For example, a feature may relate to a data acquisition unit (e.g. a counter, such as a PM counter) from which data is to be analysed. In some embodiments, the edge entity (e.g. a baseband unit of the edge entity) may comprise the data acquisition unit. A data acquisition unit can be any unit that is configured to acquire data that is to be analysed. Examples of a data acquisition unit include, but are not limited to, an equipment support unit, an equipment support function unit, a battery backup unit, or any other data acquisition unit.

Examples of a feature include, but are not limited to, a temperature (e.g. a battery temperature distribution), a fan speed, or any other feature.

In some embodiments, the first set of features referred to herein can be a set of features that the machine learning model is to take into account when analysing data. In other embodiments, the first set of features referred to herein can be a set of features from which a subset of features is selected. In these embodiments, the subset of features is a subset of features that the machine learning model is to take into account when analysing data. In some embodiments, the first set of features may be identical to a second set of features, partially different from the second set of features, or completely different from the second set of features. In embodiments where the first set of features is partially different from the second set of features, the first set of features may comprise the second set of features and at least one additional feature, the first set of features may comprise a subset of the second set of features (e.g. at least one feature of the second set of features may be omitted from the first set of features), or the first set of features may comprise at least one feature that is different from the second set of features (e.g. at least one feature of the second set of features may be replaced with another feature in the first set of features). In embodiments where the first set of features is completely different from the second set of features, the first set of features can completely overwrite the second set of features. The selection of the first set of features referred to herein can thus complement or even replace the existing dimensionality reduction techniques. Thus, the machine learning model can be updated to use the first set of features instead of the second set of features.

In some embodiments, the second set of features may be a set of features that the machine learning model previously took into account when analysing data. In this case, the second set of features may be referred to as a ‘feature space’. Thus, the selection of the first set of features can involve redefining the feature space according to some embodiments. In other embodiments, the second set of features may be a set of features from which a subset of features was selected and that the machine learning model previously took into account when analysing data. In this case, the second set of features may be referred to as an ‘input space’ and the subset of features may be referred to as the ‘feature space’. Thus, the selection of the first set of features can involve redefining the input space according to some embodiments.

In some embodiments, selecting may be performed in response to receiving (e.g. at the central entity 10, such as via the communications interface 16 of the central entity 10) an output of the machine learning model resulting from the edge entity using the machine learning model to analyse data taking into account the second set of features. Thus, in some embodiments, the output of the machine learning model can be sent to the central entity 10. The output of the machine learning model referred to herein can, for example, be the analysis results from the machine learning model. In some embodiments, the selection of the first set of features may also be based on the output of the machine learning model resulting from the edge entity using the machine learning model to analyse data taking into account the second set of features.

In some embodiments, selecting the first set of features based on the first information, the second information, the contextual information, and optionally also the output of the machine learning model can comprise applying a knowledge representation and reasoning process (or algorithm) to the first information, the second information, the contextual information, and optionally also the output of the machine learning model to select the first set of features. Herein, the knowledge representation and reasoning process can, for example, comprise any one or more of a logic-based knowledge representation and reasoning process, a rule-based knowledge representation and reasoning process, a probabilistic knowledge representation and reasoning process, a graph-based knowledge representation and reasoning process, and any other knowledge representation and reasoning process. The knowledge representation and reasoning process may be classical or non-classical. The knowledge representation and reasoning process may also be referred to as a machine reasoning process. Thus, in some embodiments, the central entity 10 can select an appropriate set of features using machine reasoning.

In some embodiments, the first set of features can be for the machine learning model to take into account when the machine learning model is used by the edge entity to analyse data to make a prediction. Alternatively or in addition, the first set of features can be for the machine learning model to take into account when the machine learning model is used to analyse data to train the machine learning model to make the prediction. In some embodiments, the machine learning model may already be trained to analyse data to make the prediction. Thus, in some embodiments, the first set of features can be for the machine learning model to take into account when the machine learning model is used to analyse data to retrain the machine learning model to make the prediction. The prediction can, for example, be a prediction of an event (e.g. alarm) in the network, a cause of the event in the network, and/or any other prediction.

Herein, a machine learning model may be trained (or retrained) using any machine learning process (or algorithm). Examples of a machine learning process include, but are not limited to, a linear regression process, a logistic regression process, a decision tree process, a neural network process, or any other machine learning process. By training (or retraining) the machine learning model in the manner described herein, the performance of the machine learning model can be improved.

Although not illustrated in FIG. 2, in some embodiments, the method may comprise initiating use of the machine learning model to analyse data taking into account the first set of features, e.g. to train the machine learning model to make a prediction, retrain the machine learning model to make the prediction, and/or to make the prediction. Thus, in some embodiments, the central entity 10 may optionally also implement solutions using the selected first set of features.

In some embodiments, the contextual information associated with the network can be contextual information associated with an environment in which the machine learning model operates. For example, the contextual information associated with the network can be contextual information associated with the edge entity according to some embodiments. Alternatively or in addition, in some embodiments, the contextual information associated with the network may be unavailable to the edge entity. That is, the contextual information associated with the network may not be available locally to the edge entity. For example, in some embodiments, the contextual information associated with the network may arise from data that is not (e.g. immediately) available to, or used by, the edge entity 20. The contextual knowledge can be any contextual knowledge associated with the network that is available centrally to the central entity 10.

In some embodiments, the contextual information may only be centrally available (e.g. only be available to the central entity 10) according to some embodiments.

Nevertheless, by way of the central entity 10 using the contextual information in the manner described herein, the contextual information that is unavailable to the edge entity is indirectly transferred and integrated into the machine learning model that is to be used at the edge entity 20.

In some embodiments, the contextual information associated with the network may comprise a characteristic of one or more network components of the network, a characteristic of an environment of the network, documentation about the network, and/or any other information associated with the network. In some embodiments, a characteristic of one or more network components of the network may be a network topology of network components of the network, a power consumption of one or more network components of the network, an environmental footprint of one or more network components of the network, and/or any other characteristic of one or more network components of the network. In some embodiments, a characteristic of an environment of the network may be the weather in the environment of the network, the power in the environment of the network, the temperature in the environment of the network, and/or any other characteristic of the environment of the network. In some embodiments, the documentation about the network can be documentation from a user (such as a customer, an operator, and/or an expert, e.g. an engineer, such as a field engineer or field service engineer), and/or the documentation can comprise reports about the network, procedural knowledge about the network, performance information about the network, and/or queries about the network.

In some embodiments, the contextual information associated with the network may comprise information that relates information (e.g. data) acquired from the one or more data acquisition units mentioned earlier to at least one potential (e.g. root) cause of at least one event (e.g. at least one alarm) in the network. For example, this information may be from an expert that previously fixed a fault in the network, which may potentially be a cause of an event. In some embodiments, the contextual information may be information that is formalised in a machine-readable format, e.g. so that it is usable by the central entity 10.

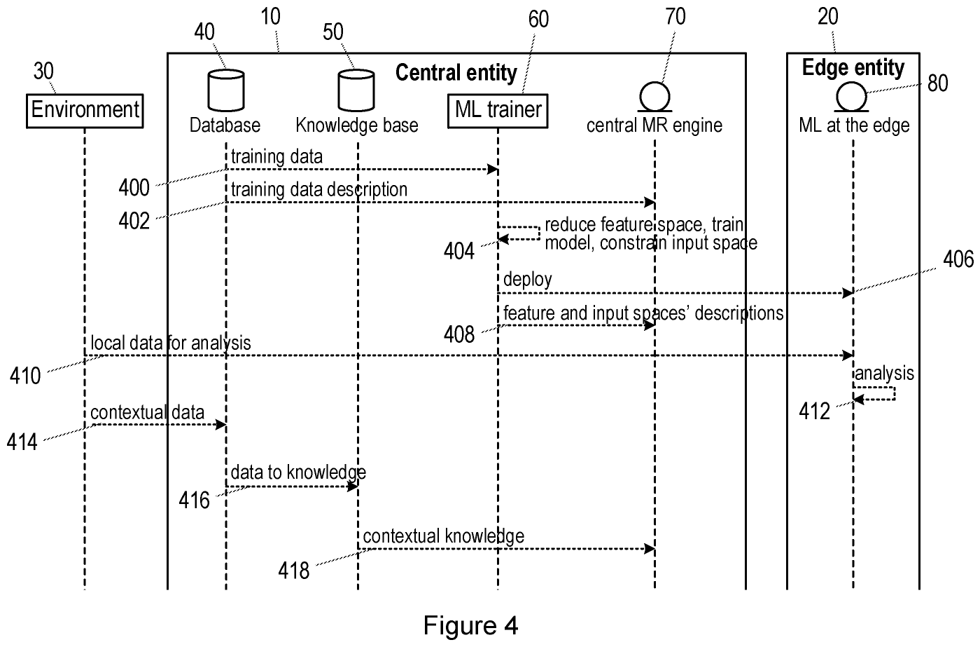

FIG. 3 illustrates a network (or system) according to an embodiment. The network illustrated in FIG. 3 comprises a central entity 10 and an edge entity 20. Although the network of FIG. 3 is illustrated as comprising a single edge entity 20, it will be understood that the network may comprise a single edge entity 20 or a plurality of edge entities 20 and the method described herein can be performed in respect of any one or more edge entities 20 of the network. The central entity 10 is as described earlier with reference to FIGS. 1 and 2.

As illustrated in FIG. 3, in some embodiments, the central entity 10 may comprise a first component (e.g. the processing circuitry 12 mentioned earlier may comprise first processing circuitry) 60. The first component 60 of the central entity 10 can be responsible for performing the selection of the first set of features. In embodiments where the selection of the first set of features involves the machine reasoning mentioned earlier, the first component 60 of the central entity 10 can be responsible for this machine reasoning. Thus, the first component 60 of the central entity 10 may also be referred to herein as a machine reasoning (MR) component or engine. In some embodiments, the first component 60 of the central entity 10 can be within an OSS or the central entity 10 itself can be within an OSS.

As illustrated in FIG. 3, in some embodiments, the central entity 10 may optionally also comprise a second component (e.g. the processing circuitry 12 mentioned earlier may comprise second processing circuitry) 70. The second component 70 of the central entity can be responsible for storing data, processing data (e.g. into knowledge), and/or performing the training (and/or retraining) of the machine learning model. Thus, the second component 70 of the central entity 10 may also be referred to herein as a data-knowledge component, a trainer, or a machine learning (ML) trainer.

As mentioned earlier, the central entity 10 can comprise a memory 14 according to some embodiments. Although not illustrated in FIG. 3, in some embodiments, this memory 14 of the central entity 10 may comprise a database and/or a knowledge base. Thus, in some embodiments, the central entity 10 can optionally also comprise a database and/or a knowledge base.

As illustrated in FIG. 3, in some embodiments, the edge entity 20 may comprise a first component (e.g. processing circuitry of the edge entity 20 may comprise first processing circuitry) 80. The first component 80 of the edge entity 20 can be responsible for performing machine learning at the edge of the network. For example, the first component 80 of the edge entity 20 can be responsible for using the machine learning model to analyse (e.g. local) data and optionally also for sending the resulting output (i.e. the analysis) results to the central entity 10. The first component 80 of the edge entity 20 may also be referred to herein as a machine learning (ML) component.

As illustrated in FIG. 3, in some embodiments, the edge entity 20 may optionally also comprise a second component (e.g. processing circuitry of the edge entity 20 may comprise second processing circuitry) 90. The second component 90 of the edge entity 20 can be responsible for acquiring the (e.g. local) data that is to be analysed. For example, the second component 90 of the edge entity 20 can be responsible for collecting this data and providing it to the first component 80 of the edge entity 20 for analysis. The second component 90 of the edge entity 20 may, for example, be a device or base station according to some embodiments. Alternatively, in some embodiments, the edge entity 20 may itself be a device or base station.

The environment 30 of the network that comprises the central entity 10 and the edge entity 20 is also illustrated in FIG. 3.

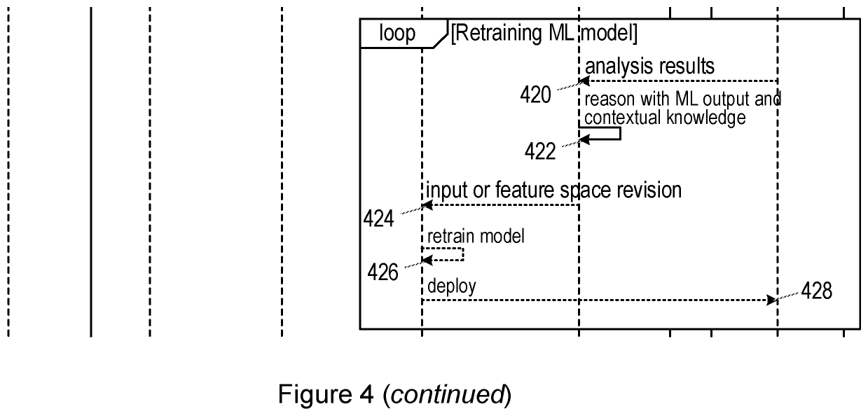

FIG. 4 is a signalling diagram illustrating an exchange of signals in such a network according to an embodiment. The network illustrated in FIG. 4 comprises the central entity 10 described earlier and an edge entity 20. Although the network of FIG. 4 is illustrated as comprising a single edge entity 20, it will be understood that the network may comprise a single edge entity 20 or a plurality of edge entities 20 and the method described herein can be performed in respect of any one or more edge entities 20 of the network.

As illustrated by arrow 400 of FIG. 4, in some embodiments, the first component 60 of the central entity 10 acquires training data from the database 40 of the central entity 10. For example, the training data can be transmitted from the database 40 of the central entity 10 to the first component 60 of the central entity 10. As illustrated by arrow 402 of FIG. 4, in some embodiments, the second component 70 of the central entity 10 acquires a description of this training data from the database 40 of the central entity 10. For example, the description of the training data can be transmitted from the database of the central entity 10 to the second component 70 of the central entity 10. As illustrated by arrow 404 of FIG. 4, in some embodiments, the first component 60 of the central entity 10 can analyse the training data to train the machine learning model to make a prediction or, if the machine learning model is already trained, retrain the machine learning model to make the prediction. The machine learning model analyses the training data taking into account the second set of features mentioned earlier. Thus, in some embodiments, training data from the database 40 of the central entity 10 can be used to train (or retrain) the machine learning model that is to be deployed at the edge entity 20.

In some embodiments, during this training (or retraining) process, the second set of features may be defined. For example, in some embodiments, the second set of features may be defined as a set of features that is to be taken into account when the machine learning model analyses the training data. This can be referred to as defining the ‘feature space’. In some embodiments, the second set of features may be defined as a set of features from which a subset of features can be selected and it is then this subset of features that is to be taken into account when the machine learning model analyses the training data. This can be referred to as defining the ‘input space’ from which the ‘feature space’ can be selected. In this case, the ‘feature space’ can be defined by constraining the ‘input space’. That is, the second set of features may be constrained to define the subset of features. A person skilled in the art will be aware of various techniques that can be used to constrain the second features to define the subset of features and examples include dimensionality reduction techniques, such as principal component analysis and/or the use of an autoencoder. Thus, in some embodiments, it may be the case that only a subset of features is taken into account when the machine learning model analyses the training data, even though more features are available.

As illustrated by arrow 406 of FIG. 4, in some embodiments, the first component 60 of the central entity 10 may initiate deployment of the machine learning model at the edge entity 20. For example, the first component 60 of the central entity 10 may initiate use of the machine learning model, at the edge entity 20, to analyse data to make the prediction taking into account the second set of features. As illustrated by arrow 408 of FIG. 4, in some embodiments, the first component 60 of the central entity 10 may initiate transmission of a description of the second set of features towards the second component 70 of the central entity 10. For example, the description of the second set of features can comprise a description of a set of features that the machine learning model took into account when analysing the training data (i.e. a feature space description) and/or a description of a set of features from which a subset of features was selected and that the machine learning model took into account when analysing the training data (i.e. an input space description). Thus, a description of the training data, feature space, and input space can be provided to the second component 70 of the central entity 10 according to some embodiments.

In some embodiments, the training data referred to herein may comprise logs of (e.g. PM) counter measurements and associated alarm(s) and/or probable root cause(s). An example of training data that comprises logs of N counter measurements and an associated alarm (namely, an environmental alarm) together with its probable root cause (namely, high temperature) is, as follows:

(counter1=val1, . . . ,counterN=valN,alarm=environmentalAlarm,prob_cause=highTemp).

Returning back to FIG. 4, as illustrated by arrow 410 of FIG. 4, the edge entity 20 (e.g. the first component 80 of the edge entity 20 via the second component 90 of the edge entity 20) can acquire data for analysis, e.g. from the environment 30 and/or provided by a base station (e.g. an RBS). The data can comprise local data. That is, the data can comprise data that is local to the edge entity 20. For example, in embodiments where the edge entity acquires data for analysis from a base station, the edge entity 20 may itself be the base station. As illustrated by arrow 412 of FIG. 4, the edge entity 20 (e.g. the first component 80 of the edge entity 20) may analyse the acquired data, taking into account the second set of features, to make a prediction. The prediction can be any of the predictions mentioned earlier or any other prediction. Thus, after deployment, the machine learning model at the edge entity 20 analyses the local data that is acquired.

As illustrated by arrows 414, 416 and 418 of FIG. 4, the second component 70 of the central entity 10 can acquire contextual information associated with the network. In some embodiments, the contextual information may be acquired from the environment 30 and/or other sources. For example, in some embodiments, as illustrated by arrow 414 of FIG. 4, the database 40 of the central entity 10 may acquire contextual data from the environment 30 and/or other sources. The database 40 of the central entity 10 may store this contextual data according to some embodiments. In an example, the contextual data may comprise values associated with the network (e.g. a temperature in the environment of the network) at different points in time. As illustrated by arrow 416 of FIG. 4, in some embodiments, the contextual data may be processed (or converted, e.g. using machine reasoning) into contextual knowledge to be used by the second component 70 of the central entity 10. The knowledge base 50 of the central entity 10 may store this contextual knowledge according to some embodiments. The processing of the contextual data into contextual knowledge may be performed automatically and/or may comprise applying background procedural knowledge to the contextual data to deduce a trend in the contextual data over a period of time. Thus, in some embodiments, the contextual knowledge can comprise a trend in the contextual data (e.g. a trend, such as an increase, in a temperature in the environment of the network over a period of time). As illustrated by arrow 418 of FIG. 4, the second component 70 of the central entity 10 can acquire this contextual knowledge from the knowledge base 50 of the central entity 10. In the embodiment illustrated in FIG. 4, this contextual knowledge is the contextual information associated with the network, which is used by the second component 70 of the central entity 10.

As illustrated by arrow 420 of FIG. 4, in some embodiments, the edge entity 20 (e.g. the first component 80 of the edge entity 20) may transmit the output of the machine learning model toward the central entity 10. Thus, in some embodiments, the second component 70 of the central entity 10 can receive the output of the machine learning model. The output of the machine learning model is that which results from the edge entity 20 using the machine learning model to analyse the acquired data taking into account the second set of features. As illustrated by arrow 422 of FIG. 4, the second component 70 of the central entity 10 selects the first set of features referred to earlier for the machine learning model to take into account when analysing data. In some embodiments, the selecting can be performed in response to receiving the output of the machine learning model.

As mentioned earlier, the selection is based on first information indicative of data that is available for the machine learning model to analyse, second information indicative of features that are available for the machine learning model to take into account when analysing data, the contextual information associated with the network, and optionally also the output of the machine learning model. For example, as mentioned earlier, this selection may involve a machine reasoning process according to some embodiments. Thus, in some embodiments, the second component 70 of the central entity 10 can reason with the output of the machine learning model and the contextual information associated with the network (and optionally also any other information or knowledge available to it) to select the first set of features. While the existing dimensionality reduction techniques are statistical and work on a given data set, the technique described herein can be non-statistical. In particular, the first set of features is selected using contextual knowledge and can be selected by way of machine reasoning, which avoids the need for the statistical methods of dimensionality reduction that are currently used in training machine learning models. Thus, advantageously, the technique described herein uses (e.g. logic-based, rule-based, probabilistic, a graph-based, and/or similar) reasoning techniques and knowledge that is external to dimensionality reduction to complement the feature selection process in machine learning.

As illustrated by arrow 424 of FIG. 4, in some embodiments, the second component 70 of the central entity 10 may initiate transmission of the first set of features towards the first component 60 of the central entity 10. Thus, in some embodiments, the first component 60 of the central entity 10 may receive the first set of features. As mentioned earlier, the first set of features may be identical to the second set of features, partially different from the second set of features, or completely different from the second set of features. In embodiments where the second set of features is a set of features that the machine learning model previously took into account when analysing data and the first set of features is (partially or completely) different from the second set of features, it can be said that there is a feature space revision. That is, the feature space is redefined. In other embodiments where the second set of features is a set of features from which a subset of features was selected and that the machine learning model previously took into account when analysing data, and the first set of features is (partially or completely) different from the second set of features, it can be said that there is an input space revision. That is, the input space is redefined.

As illustrated by arrow 426 of FIG. 4, in some embodiments, the first component 60 of the central entity 10 may initiate use of the machine learning model to analyse data, taking into account the first set of features, to retrain the machine learning model to make the prediction. Thus, in some embodiments, second component 70 of the central entity can suggest the retraining to the first component of the central entity 10. As the retraining takes into account the first set of features, rather than the second set of features, the machine learning model uses a revised feature space and/or input space in embodiments where the first set of features is (partially or completely) different from the second set of features. In some embodiments, a revised feature space may involve forcing an output of an autoencoder. In some embodiments, a revised input space may involve prompting use of existing and/or new network components (e.g. counters, such as PM counters) to complement the previous input space with additional features.

As illustrated by arrow 428 of FIG. 4, in some embodiments, the first component 60 of the central entity 10 may initiate deployment of the machine learning model at the edge entity 20. For example, the first component 60 of the central entity 10 may initiate use of the machine learning model, at the edge entity 20, to analyse data to make the prediction taking into account the first set of features. Thus, in some embodiments, the edge entity 20 may analyse data to make the prediction taking into account the first set of features. In some embodiments, the prediction may be applied to the network. For example, in embodiments where the prediction is a cause of the event in the network, the prediction may be applied to the network to prevent the cause of the event in the network in the future. As illustrated in FIG. 4, the method described with reference to arrows 420 to 428 may be performed iteratively (e.g. in a loop) according to some embodiments.

Thus, according to the technique described herein, an output from a machine learning model deployed at the edge entity 20 is triggered, there is a period of analysis by the central entity 10 using the output and the contextual information to select the first set of features, and the selected first set of features are subsequently taken into account when analysing data using the machine learning model (e.g. the first set of features may be forced in the data analysis). Some examples of the technique described herein will now be described with respect to specific use cases.

A first example of the technique described herein involves a feature space revision using machine reasoning. In this first example, the edge entity 20 is a base station (e.g. RBS) and the machine learning model is deployed at the base station. The machine learning model is for root cause analysis (RCA) of alarms. The alarms of any (potential) issues are raised by a baseband unit of the base station, e.g. based on information acquired from one or more counters (e.g. PM counters). The information acquired from one or more counters, the alarms, and the output of the machine learning model are sent to the central entity 10 (e.g. of an OSS) for verification and resolution. In this first example, the output of the machine learning model is the potential root cause of the alarms predicted by the machine learning model.

It is often the case that any issue will have multiple potential root causes and these root causes can be context-dependent. Even when contextual information associated with the network is available for reasoning by engineers, existing techniques do not actually make use of this contextual information in selecting a set of features for the machine learning model to take into account when analysing data. Advantageously, the central entity 10 described herein does make use of this contextual information. In this first example, the central entity 10 (or, more specifically, the second component 70 of the central entity 10) selects a first set of features for the machine learning model to take into account when analysing data and this selection is based on first information indicative of data that is available for the machine learning model to analyse, second information indicative of features that are available for the machine learning model to take into account when analysing data, contextual information associated with the network, and optionally also the output of the machine learning model. As mentioned earlier, in some embodiments, the selection of the first set of features can comprise applying machine reasoning to the first information, the second information, the contextual information, and optionally also the output of the machine learning model to select the first set of features.

Thus, in this first example, the machine reasoning allows the central entity 10 (or, more specifically, the second component 70 of the central entity 10) to infer what first set of features can be used to confirm a proposed root cause or explain an alarm and point to other or more likely root causes. The first set of features may be inferred using the contextual information associated with the network and optionally also given the raised alarms and proposed root causes. The central entity 10 may know whether the first set of features is obtainable from the data that is available to, but was not used by, the machine learning model at the edge entity 20 since the central entity 10 may hold data descriptions and receive counter information. If the first set of features is obtainable from the data that is available to, but was not used by, the machine learning model at the edge entity 20, then the central entity 10 can select that first set of features and suggest that the machine learning model is retrained taking into account the selected first set of features.

For instance, the central entity 10 may have a connection to a weather service in the environment of the deployed edge entity 20 for contextual information associated with the network. Suppose an EnvironmentalAlarm is raised and probable causes include High Temperature in EquipmentSupportUnit and Temperature Unacceptable in EquipmentSupportFunction BatteryBackup. The counters used to hypothesise this probable cause include BatteryTemperatureDistr but not FanSpeed. The counters used are referred to herein as the second set of features that the machine learning model previously took into account when analysing data.

Using contextual information associated with the network, which is weather information indicative that it is hot in the environment of the edge entity 20, the central entity 10 determines that BatteryTemperatureDistr is affected by outdoor temperature and thus that FanSpeed information is important to verify the root cause or improve the determination of the root cause. Thus, the first set of features selected by the central entity 10 in this first example comprises FanSpeed. The machine learning model at the edge entity 20 may therefore be instructed to use FanSpeed as a feature for RCA in the future.

The technical setup according to this first example can be as follows:
1. The initial input space (i.e. the available features from which a subset of features is selected) comprises, say, 100 features pertaining to counters, such as BatteryTemperatureDistr and FanSpeed.
2. The feature space (i.e. the subset of features) is selected by an autoencoder and comprises, say, 50 of the features from the input space. For instance, BatteryTemperatureDistr is in the feature space, but FanSpeed is not.
3. The machine learning model is trained using the 50 features to predict the probable root causes of the alarms based on the previously observed measurements of the 50 counters, the associated alarms and root causes. In deployment, the machine learning model predicts the probable root causes of the observed alarms and sends them to the central entity 10 for solving the problems.
4. The central entity 10 (or, more specifically, the second component 70 of the central entity 10) can operate a reasoner that has access to the contextual information associated with the network. For instance, a rule-based reasoner may be used, where the reasoner can have a rule expressing that “IF WeatherTemperature>30 C AND High Temperature(EquipmentSupportUnit)=true THEN affected(BatteryTemperatureDistr) UNLESS FanSpeed<3000 rpm”. Upon receiving the analysis from the machine learning model, the reasoner can infer that FanSpeed measurement needs to be used to better determine the root cause of the alarm in case of hot weather. After a period of time, the central entity (or, more specifically, the second component 70 of the central entity 10) thus selects a first set {FanSpeed, . . . } of, say, 10 features among the 100 describing the initial input space that it deems important for alarm RCA.
5. The second component 70 of the central entity 10 may send the selected first set of 10 features to the first component 60 of the central entity 10 for the first component 60 of the central entity 10 to retrain the deployed machine learning model with the 10 features enforced. Some of those features, say 5, but not including FanSpeed, may already be within the 50 in the initial feature space.
6. The machine learning model is retrained using the selected first set of features. For instance, the new feature space may comprise 55 features, which may comprise the 50 features previously determined by the autoencoder and the 5 new features. Alternatively, the new feature space may comprise 50 features again, but this time the autoencoder may have the 10 features sent by the central entity 10 enforced onto it and may itself determine the other 40 features.

As an alternative to the connection to a weather service, the central entity 10 may have a connection to a supervisory control and data acquisition (SCADA) system (or any other power network) for contextual information associated with the network. In this case, for instance, if a “low bitrate” alarm is raised with probable causes pertaining to battery power levels and unit failures, the central entity 10 (or, more specifically, the second component 70 of the central entity 10) can infer from the contextual information that fluctuations in the power network affect batteries and that unit functionality counters are to be taken into account. Thus, the central entity 10 (or, more specifically, the second component 70 of the central entity 10) may select a first set of features comprising unit functionality counters.

As an alternative to the connection to a weather service or a SCADA system, the central entity 10 may have access to a document storage of an operator of the network for the contextual information associated with the network. For instance, the contextual information may be customer product information (CPI) and/or may comprise troubleshooting documentation (e.g. populated by engineers) on how to resolve a fault and/or workflows on how to resolve faults and which features (e.g. counters, such as PM counters) to check. With existing techniques, an autoencoder may miss a feature pertaining to counters of rising temperatures because there are a large number of such counters. For instance, board temperature may be irrelevant and instead ambient temperatures may matter the most but this cannot be known a priori statistically. However, advantageously, this can be captured in the contextual information associated with the network, which is used in the technique described herein. This contextual information can comprise documentation (e.g. from engineers) that indicates which particular features actually matter.

For instance, assume that a TemperatureExceptionallyHigh alarm is raised in the network. With existing techniques, an autoencoder may find many other related alarms such as FanFailure, FanAirTemperatureExtremelyHigh, FanHWFault, RBSTemperatureOutofRange, ExternalAlarm, Temperature SupervisionFailure, Disconnected, BoardOverheated, and select those features as potential input to the machine learning model to establish a root cause of the alarm. However, using the technique described herein, it may be inferred from the contextual information associated with the network that only three alarms are related to the TemperatureExceptionallyHigh alarm, namely the alarms Disconnected, ExternalAlarm, and FanFailure. An alarm list make be checked for possible related alarms such as the three mentioned. If present, it may be that the procedure in the respective alarm operator interface (OPI) must be followed and no further action in this OPI is necessary. This type of contextual information can, for instance, be stored in the knowledge base 50 of central entity 10, e.g. as “contextual data and knowledge”. It may not exist in natural language format but may instead have some entity relationship representation, such as a knowledge graph, e.g. obtained using natural language processing.

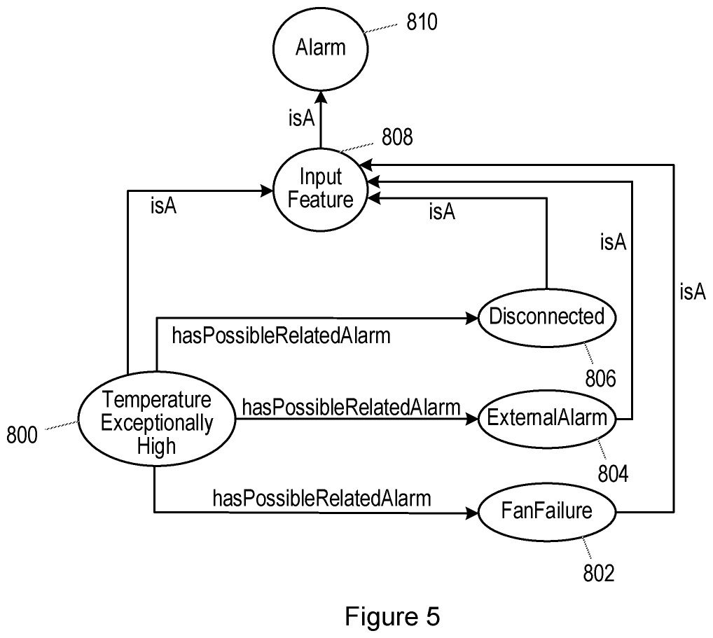

FIG. 5 illustrates such a knowledge graph. This graph can be queried by the central entity 10 (or, more specifically, the second component 70 of the central entity 10), e.g. using rule-based reasoning, to deduce relationships. Thus, this is an example of using a rule-based knowledge representation and reasoning process together with a graph-based knowledge representation and reasoning process. For instance, by querying the graph of FIG. 5, the central entity 10 (or, more specifically, the second component 70 of the central entity 10) can deduce that the TemperatureExceptionallyHigh alarm 800 is related to the three other alarms, namely, FanFailure 802, ExternalAlarm 804, and Disconnected 806. Thus, the first set of features 808 that are selected by the central entity 10 (or, more specifically, the second component 70 of the central entity 10) may comprise these four alarms 800, 802, 804, 806 as features that the machine learning model is to take into account when analysing data to establish a root cause of an alarm 810. In this way, the feature selection of an autoencoder can be narrowed down.

Other types of documentation for use as contextual information associated with the network may require more sophisticated reasoning techniques. For instance, this may be the case where the documentation is not CPI (which is limited and often generic in terms of troubleshooting issues) and instead comprises customer support requests (CSRs). CSRs are more detailed in their description and can often include different workflows/alternatives that engineers on site may have tried in order to solve an issue.

For instance, the issue may be that a backhaul connection between a gNB and the core network failed. One engineer, in their CSR, may look into key performance indicators (KPIs) or PM counters and find that, if the number of data connections terminated due to congestion (pmNoOfTermCsCong) is more than 50 and if the total amount of time a cell is congested in downlink and uplink (pmTotalTimeDLCellCong and pmTotalTimeULCellCong) is more or equal than 120 seconds, then the backhaul fails. Another engineer, in their CSR, may look into relevant alarms that are sometimes raised, such as not being able to communicate with a network time protocol (NTP) server over the backhaul to update time (CalendarClockNTPServerUnavailable) but also an alarm indicating a fault on an ethernet connection from a switch of the gNB towards a core network (GigabitEthernetLinkFault). This type of contextual information can, for instance, be stored in the knowledge base 50 of central entity 10, e.g. as “contextual data and knowledge”. It may not exist in natural language format but may instead have some entity relationship representation, such as a knowledge graph, e.g. obtained using natural language processing.

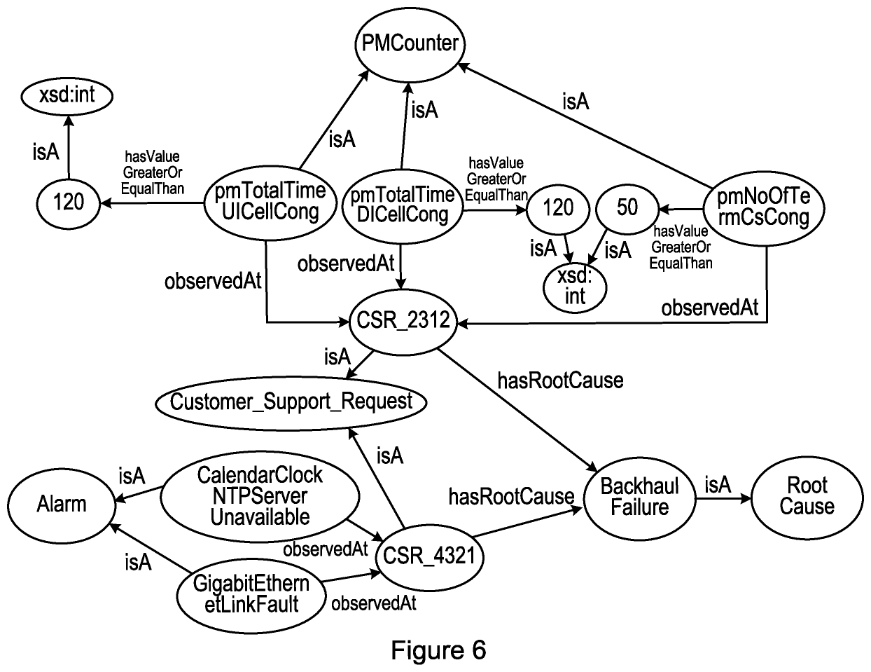

FIG. 6 illustrates such a knowledge graph. This graph can be queried by the central entity 10 (or, more specifically, the second component 70 of the central entity 10), e.g. using rule-based reasoning, to deduce relationships. Thus, this is another example of using a rule-based knowledge representation and reasoning process together with a graph-based knowledge representation and reasoning process. For instance, by querying the graph of FIG. 6, the central entity 10 (or, more specifically, the second component 70 of the central entity 10) can deduce that both feature groups (PMCounters and Alarms) are interesting for training a machine learning model to analyse data to predict a root cause of a backhaul failure. Thus, in this case, the first set of features that are selected by the central entity 10 (or, more specifically, the second component 70 of the central entity 10) may comprise PMCounters and Alarms as features that the machine learning model is to take into account when analysing data to predict a root cause of a backhaul failure.

A second example of the technique described herein involves an input space revision using machine reasoning. In large networks (e.g. metropolitan cities), transferring data from PM counters is expensive, so the PM counter data is often not collected. However, it may be known to the central entity 10 that such data is, in principle, available. The central entity 10 (or, more specifically, the second component 70 of the central entity 10) may determine from contextual information associated with the network that some PM counters (say 5 of them) are important for a machine learning model deployed at the edge entity 20. However, the measurements of those PM counters are not collected. That is, the corresponding features do not even appear in the initial input space (described e.g. by 100 features). This initial input space is the second set of features referred to herein that the machine learning model previously took into account when analysing data. Nonetheless, the measurements of the PM counters that were not collected are actually available to collect. Thus, in this case, the first set of features selected by the central entity 10 (or, more specifically, the second component 70 of the central entity 10), for the machine learning model to subsequently take into account when analysing data, comprises those PM counters that are determined to be important.

In this second example, the central entity 10 (or, more specifically, the second component 70 of the central entity 10) may suggest that the machine learning model is retrained using the selected first set of features. That is, the central entity 10 (or, more specifically, the second component 70 of the central entity 10) may suggest modifying the initial input space (e.g. to comprise a set of 105 features) and enforcing the previously unused features when performing dimensionality reduction (e.g. force the feature space to comprise the 5 features plus some extra features selected by an autoencoder). Overall, this means changing both the input and feature spaces of the machine learning model to be deployed at the edge entity 20 by using the contextual information associated with the network, which is available to the central entity 10.

A third example of the technique described herein involves replacing machine learning dimensionality reduction with machine reasoning. In this third example, the central entity (or, more specifically, the second component 70 of the central entity 10) may completely replace the existing dimensionality reduction techniques, such as the use of autoencoders. In particular, the central entity 10 (or, more specifically, the second component 70 of the central entity 10) can determine upfront the input and feature spaces, e.g. for training a machine learning model and/or using the machine learning model to make a prediction at the edge entity 20. For instance, the central entity 10 (or, more specifically, the second component 70 of the central entity 10) may determine that PM counters are useful for the prediction of a root cause of a backhaul failure and may thus select the first set of features, for the machine learning model to take into account when analysing data, to be exactly those 5 PM counters. In this case, the input and feature spaces are the same. The machine learning model may then be trained and work on data described by the selected first set of features. In this way, the existing statistical dimensionality reduction methods that process the input space to obtain a reduced feature space can effectively be replaced with (e.g. logic-based, rule-based, probabilistic, a graph-based, and/or similar) reasoning methods using contextual knowledge associated with the network.

There is also provided a computer program comprising instructions which, when executed by processing circuitry (such as the processing circuitry 12 of the central entity described earlier), cause the processing circuitry to perform at least part of the method described herein. There is provided a computer program product, embodied on a non-transitory machine-readable medium, comprising instructions which are executable by processing circuitry (such as the processing circuitry 12 of the central entity 10 described earlier) to cause the processing circuitry to perform at least part of the method described herein. There is provided a computer program product comprising a carrier containing instructions for causing processing circuitry (such as the processing circuitry 12 of the central entity 10 described earlier) to perform at least part of the method described herein. In some embodiments, the carrier can be any one of an electronic signal, an optical signal, an electromagnetic signal, an electrical signal, a radio signal, a microwave signal, or a computer-readable storage medium.

In some embodiments, the central entity functionality described herein can be performed by hardware. Thus, in some embodiments, the central entity 10 described herein can be a hardware node. However, it will also be understood that optionally at least part or all of the central entity functionality described herein can be virtualized. For example, the functions performed by the central entity 10 described herein can be implemented in software running on generic hardware that is configured to orchestrate the central entity functionality. Thus, in some embodiments, the central entity 10 described herein can be a virtual node. In some embodiments, at least part or all of the central entity functionality described herein may be performed in a network enabled cloud. Thus, the method described herein can be realised as a cloud implementation according to some embodiments. The central entity functionality described herein may all be at the same location or at least some of the central entity functionality may be distributed, e.g. the central entity functionality may be performed by one or more different entities.

It will be understood that at least some or all of the method steps described herein can be automated in some embodiments. That is, in some embodiments, at least some or all of the method steps described herein can be performed automatically. The method described herein can be a computer-implemented method.

Thus, in the manner described herein, there is advantageously provided an improved technique for selecting a set of features for a machine learning model to take into account when analysing data. By revising the set of features previously taken into account with this selection, which is advantageously based on contextual information associated with the network, the performance of the machine learning model can be improved.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method performed by a central entity of a network, the method comprising:
selecting a first set of features for a machine learning model to take into account when analysing data, wherein the machine learning model is to be deployed at an edge entity of the network; and
the selection being based on first information indicative of data that is available for the machine learning model to analyse, second information indicative of features that are available for the machine learning model to take into account when analysing data, and contextual information associated with the network.

2. The method as claimed in claim 1, wherein:
the first set of features is:
a set of features that the machine learning model is to take into account when analysing data; or
a set of features from which a subset of features is selected, wherein the subset of features is a subset of features that the machine learning model is to take into account when analysing data.

3. The method as claimed in claim 1, wherein:
the first set of features is:
identical to a second set of features;
partially different from a second set of features; or
completely different from a second set of features; and
the second set of features is:
a set of features that the machine learning model previously took into account when analysing data; or
a set of features from which a subset of features was selected and that the machine learning model previously took into account when analysing data.

4. The method as claimed in claim 3, wherein:
the selecting is performed in response to receiving an output of the machine learning model resulting from the edge entity using the machine learning model to analyse data taking into account the second set of features.

5. The method as claimed in claim 1, wherein:
selecting the first set of features based on the first information, the second information, and the contextual information comprises:
applying a knowledge representation and reasoning process to the first information, the second information, and the contextual information to select the first set of features.

6. The method as claimed in claim 5, wherein:
the knowledge representation and reasoning process comprises any one or more of:
a logic-based knowledge representation and reasoning process;
a rule-based knowledge representation and reasoning process;
a probabilistic knowledge representation and reasoning process; and
a graph-based knowledge representation and reasoning process.

7. The method as claimed in claim 1, wherein one or both:
the first set of features is for the machine learning model to take into account when the machine learning model is used by the edge entity to analyse data to make a prediction; and
the first set of features is for the machine learning model to take into account when the machine learning model is used to analyse data to train the machine learning model to make the prediction.

8. The method as claimed in claim 7, wherein:
the machine learning model is already trained to analyse data to make the prediction; and
the first set of features is for the machine learning model to take into account when the machine learning model is used to analyse data to retrain the machine learning model to make the prediction.

9. The method as claimed in claim 7, wherein:
the prediction is one or both of a prediction of an event in the network and a cause of the event in the network.

10. The method as claimed in claim 1, the method comprising:
initiating use of the machine learning model to analyse data taking into account the first set of features.

11. The method as claimed in claim 1, wherein:
the data that is available for the machine learning model to analyse comprises data that is local to the edge entity.

12. The method as claimed in claim 1, wherein one or both:
the contextual information associated with the network is unavailable to the edge entity; and
the contextual information associated with the network is contextual information associated with the edge entity.

13. The method as claimed in claim 1, wherein:
the contextual information associated with the network comprises one or more of:
a characteristic of one or more network components of the network;
a characteristic of an environment of the network; and
documentation about the network.

14. The method as claimed in claim 1 wherein one or both:
the central entity is an entity of an operations support system, OSS, of the network; and
the edge entity is a base station of the network.

15. A central entity comprising processing circuitry configured to:
select a first set of features for a machine learning model to take into account when analysing data, the machine learning model being deployable at an edge entity of the network; and
the selection being based on first information indicative of data that is available for the machine learning model to analyse, second information indicative of features that are available for the machine learning model to take into account when analysing data, and contextual information associated with the network.

16. (canceled)

17. The central entity as claimed in claim 15, wherein:
the central entity further comprises:
at least one memory for storing instructions which, when executed by the processing circuitry, cause the central entity to perform the selecting.

18. A network comprising:
a central entity comprising processing circuitry configured to:
select a first set of features for a machine learning model to take into account when analysing data, the machine learning model being deployable at an edge entity of the network; and
the selection being based on first information indicative of data that is available for the machine learning model to analyse, second information indicative of features that are available for the machine learning model to take into account when analysing data, and contextual information associated with the network; and
the edge entity.

19. (canceled)

20. A non-transitory computer storage medium, comprising instructions which are executable by processing circuitry to cause the processing circuitry to perform a method, the method comprising:
selecting a first set of features for a machine learning model to take into account when analysing data, the machine learning model being deployable at an edge entity of the network; and
the selection being based on first information indicative of data that is available for the machine learning model to analyse, second information indicative of features that are available for the machine learning model to take into account when analysing data, and contextual information associated with the network.

21. The method as claimed in claim 2, wherein:
the first set of features is:
identical to a second set of features;
partially different from a second set of features; or
completely different from a second set of features; and
the second set of features is:
a set of features that the machine learning model previously took into account when analysing data; or
a set of features from which a subset of features was selected and that the machine learning model previously took into account when analysing data.

22. The method as claimed in claim 21, wherein:
the selecting is performed in response to receiving an output of the machine learning model resulting from the edge entity using the machine learning model to analyse data taking into account the second set of features.
